(19) United States
(12) Patent Application Publication
(10) Pub. No.: US 2022/0282791 A1
(43) Pub. Date: Sep. 8, 2022

(54) SEAL RING

(71) Applicant: Carl Freudenberg KG, Weinheim (DE)

(72) Inventors: Erich Prem, Hemsbach (DE); Daniel Froelich, Weinheim (DE)

(21) Appl. No.: 17/687,709

(22) Filed: Mar. 7, 2022

(30) Foreign Application Priority Data
Mar. 8, 2021 (DE) 10 2021 105 500.8

(51) Int. Cl. F16J 15/3228; F16J 15/3268

(52) U.S. Cl. CPC F16J 15/3228; F16J 15/3268

(57) ABSTRACT

A seal ring includes: a static seal seat arranged inside the seal ring in a radial direction; and two sealing lips arranged outside the seal seat in the radial direction, the two sealing lips being axial sealing lips, one sealing lip of the axial sealing lips being a radially inner first and an other sealing lip of the axial sealing lips being a radially outer second axial sealing lip, the second axial sealing lip enclosing the first axial sealing lip at a radial distance on an outer circumference. The first axial sealing lip has greater flexibility in the radial direction than the second axial sealing lip. The second axial sealing lip has a surface structure radially externally on a side facing radially away from the first axial sealing lip, which surface structure is aerodynamically active during an intended use of the seal ring, so as to swirl an air layer.

### CROSS-REFERENCE TO PRIOR APPLICATION

Priority is claimed to German Patent Application No. DE 10 2021 105 500.8, filed on Mar. 8, 2021, the entire disclosure of which is hereby incorporated by reference herein.

### FIELD

The invention relates to a seal ring comprising a static seal seat arranged in the radial direction inside the seal ring and two sealing lips arranged in the radial direction outside the seal seat, wherein the sealing lips are designed as axial sealing lips, wherein one of the axial sealing lips is formed as a radially inner first and one of the axial sealing lips is formed as a radially outer second axial sealing lip and wherein the second axial sealing lip encloses the first axial sealing lip at a radial distance on the outer circumference.

### BACKGROUND

Such a seal ring is generally known. The seal ring is arranged with its static seal seat in a rotationally fixed manner on a first machine element to be sealed, for example a shaft, and, with its two axial sealing lips, rests in a dynamically sealing manner against a sealing surface extending in the radial direction of a second machine element to be sealed, for example a housing, which encloses the shaft at a radial distance.

Normally, such dynamic sealing by the axial sealing lips is poorly lubricated or not lubricated at all. Increased wear and premature failure of the seal ring can therefore occur especially at high relative speeds of the machine elements to be sealed against one another.

If the axial contact pressure of the axial sealing lips on the machine element to be sealed is reduced, the friction and hence the wear is also reduced. However, this also reduces the sealing effect, so that a sealing arrangement in which such a seal ring is used has no satisfactory performance characteristics overall; in particular, it has an undesirably short service life.

### SUMMARY

In an embodiment, the present invention provides a seal ring, comprising: a static seal seat arranged inside the seal ring in a radial direction; and two sealing lips arranged outside the seal seat in the radial direction, the two sealing lips comprising axial sealing lips, one sealing lip of the axial sealing lips comprises a radially inner first and an other sealing lip of the axial sealing lips comprising a radially outer second axial sealing lip, the second axial sealing lip enclosing the first axial sealing lip at a radial distance on an outer circumference, wherein the first axial sealing lip has greater flexibility in the radial direction than the second axial sealing lip, and wherein the second axial sealing lip has a surface structure radially externally on a side facing radially away from the first axial sealing lip, which surface structure is aerodynamically active during an intended use of the seal ring, so as to swirl an air layer adjoining the surface structure and an to repel contaminants from surroundings of the seal ring.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a sealing arrangement in which the seal ring according to the invention is used,

FIG. 2 shows a perspective view of the seal ring of FIG. 1, and

FIG. 3 shows an enlarged view of the surface of the seal ring of FIG. 2.

### DETAILED DESCRIPTION

In an embodiment, the present invention provides further develops a seal ring of the type mentioned at the outset in such a way that it has good performance characteristics during a long service life, even when the seal ring is used at high rotational speeds of the machine element to be sealed. The seal ring should also be able to be operated with low friction and in an energy-efficient manner.

To achieve the object, a seal ring is provided, as described above, wherein the first axial sealing lip has a greater flexibility in the radial direction than the second axial sealing lip, and wherein the second axial sealing lip has a surface structure radially externally on the side facing radially away from the first axial sealing lip, which surface structure is aerodynamically active during the intended use of the seal ring, for swirling the air layer adjoining the surface structure and for repelling contaminants from the surroundings of the seal ring.

The following is carried out for the seal ring to function:

Due to the design and arrangement of the axial sealing lips, only a low friction torque is generated even at high rotational speeds, and energy losses during the operation of the seal ring are minimal.

The radially inner first axial sealing lip is designed such that it is relieved at higher rotational speeds as a result of centrifugal forces and thereby generates only a low friction torque. In order to compensate for the resulting slightly reduced sealing reliability, the surface structure is provided on the side of the second axial sealing lip facing radially away, which generates a swirled air flow when the seal ring rotates, that is to say during the intended use. This air flow keeps contaminants away from the sealing point and compensates for the reduced sealing reliability caused by the reduced contact pressure of the first axial sealing lip as a result of the centrifugal force. It is noteworthy that the advantageous performance characteristics are achieved by the surface structure without an additional friction torque being generated.

By combining the first axial sealing lip, which is relieved by centrifugal force, with the aerodynamically active surface structure of the second axial sealing lip, the seal ring can be operated with very low friction and in an energy-efficient manner even at high speeds. At the same time, an almost uniform robustness of the seal ring and thus of a sealing arrangement, in which the seal ring is used, is achieved at all rotational speeds. At low rotational speeds, the robustness results from the axial sealing lips contacting a surface to be sealed, while at higher rotational speeds it results primarily from the generated air flow as a result of the aerodynamically active surface structure.

Given that the static seal seat is arranged in a rotationally fixed manner on a machine element to be sealed, it rotates with the rotational speed thereof.

In order to achieve as long a service life as possible with consistently good performance characteristics, the seal ring according to the invention can comprise intrinsic lubrication.

In order to realize the intrinsic lubrication of the dynamically effective axial sealing lips, it can be provided according to a first embodiment that a grease reservoir is arranged in the radial direction between the two axial sealing lips. When designing the axial sealing lips, it must be ensured that the radially outer axial sealing lip is dimensioned rigidly enough so as to retain the grease used.

According to a second embodiment, it can be provided that the axial sealing lips have a friction-reducing and thus wear-reducing surface coating.

The grease reservoir and the wear-reducing coating can also be combined with one another.

According to an advantageous embodiment, it can be provided that the static seal seat and the axial sealing lips each consist of a rubber-elastic sealing material. Rubber-elastic sealing materials are known in many different specifications for different applications and are often easily available.

The seal seat and the axial sealing lips are preferably formed such as to merge into one another in one piece and are composed of a single material. The seal ring can thus be produced easily, reliably and cost-efficiently and can be recycled as a pure material.

The seal ring can comprise an essentially L-shaped supporting body made of a tough material, wherein the supporting body is at least essentially enclosed by the rubber-elastic sealing material. Here, it is advantageous that the static seal seat is held by the supporting body in a reliable and sealing manner on a machine element, for example on a shaft. In the installed state of the seal ring, a leg of the supporting body encloses the seal seat on the outer circumference and with radial pretensioning. It is also advantageous that the supporting body is well protected from ambient conditions by the sealing material. For example, an anti-corrosion coating to be applied separately is not required.

The supporting body can comprise an axial leg that encloses the static seal radially on the outer circumference. The axial leg presses the static seal seat in a sealing manner, under elastic pretensioning, onto a surface to be sealed of a machine element to be sealed of a sealing arrangement.

The supporting body can also comprise a radial leg to which the axial sealing lips are hinged. The spatial assignment of the axial sealing lips to one another and to the static seal seat is clearly defined by the supporting body. Deformation of the seal ring caused by relaxation is practically prevented by the supporting body.

On its side facing away from its free end, the first axial sealing lip can have a joint-like root region, which is tapered when viewed in cross-section. As a result of such configuration, the first axial sealing lip has greater flexibility in the radial direction than the second axial sealing lip. Due to the joint-like root region, the pressing of the first axial sealing lip against a surface to be sealed is significantly reduced during the intended use of the seal ring during rotation, to such an extent that the friction is also reduced and the energy efficiency of the seal ring is increased. The first axial sealing lip is designed in such a way that it contacts a surface to be sealed, in an adjoining manner, at maximum rotational speed either barely, virtually without axial pretensioning, or even lifts off from the surface to be sealed. The first axial sealing lip then generates practically no friction torque.

The sealing effect is then essentially effected only by the radially outer second axial sealing lip.

The second axial sealing lip is designed such as to “barely contact” the surface to be sealed. That is to say, a slight overlap or a minimum gap is produced here depending on the tolerance position. At maximum speed, the first axial sealing lip is significantly relieved in its pressing force against the counter face, but it will not lift off. The aerodynamic sealing effect compensates for the reduced sealing effect due to lower axial contact pressure of the radially inner first axial sealing lip.

The surface structure can have elevations and depressions, which are formed in an alternating manner when viewed in the circumferential direction. The aerodynamic surface structure can be designed differently, depending on the particular application. For example, it is possible to design the surface structure such that it always functions consistently well, regardless of the direction of rotation of the seal ring.

According to another embodiment, it can be provided that the surface structure is directionally effective and therefore functions only in one direction of rotation.

The air layer adjoining the surface structure is swirled by the deflection of the air flow in the region of the surface structure. As a result, contaminants from the surroundings are prevented from penetrating toward the axial sealing lips and into a space to be sealed.

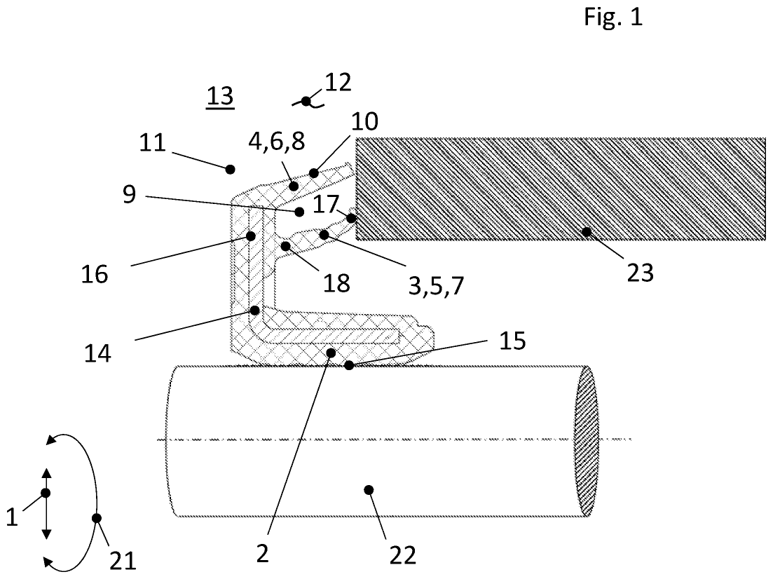

FIG. 1 shows a sealing arrangement in section. In the sealing arrangement, the seal ring according to the invention is used. The seal ring seals two machine elements 22, 23 against each other. In the exemplary embodiment shown, the first machine element 22 is formed by a shaft to be sealed, and the second machine element 23 is formed by a housing to be sealed.

The seal ring is arranged on the first machine element 22 in a rotationally fixed manner by means of its static seal seat 2. The seal between the seal ring and the first machine element 22 is realized by the static seal seat 2 arranged inside in the radial direction 1 of the seal ring.

The second machine element 23 is sealed by the sealing lips 3, 4, each formed as axial sealing lip 5, 6. The first axial sealing lip 7 is arranged radially inside, and the second axial sealing lip 8 is arranged radially outside the seal ring.

A barrier grease can be arranged in the gap formed between the two axial sealing lips 7, 8 by the radial distance 9.

The first axial sealing lip 7 has greater flexibility in the radial direction 1 than the second axial sealing lip 8. On its side facing away from its free end 17, the first axial sealing lip 7 has the joint-like root region 18, which, as shown here, is tapered when viewed in cross-section.

The second axial sealing lip 8 has the aerodynamically effective surface structure 10 radially externally on the side facing radially away from the first axial sealing lip 7. When the seal ring rotates, swirls of the air layer 11 adjoining the surface structure 10 are thus produced and contaminants 12 from the surroundings 13 are repelled.

The higher the rotational speed at which the seal ring rotates together with the first machine element 22 to be sealed, the lower the pressing of the first axial sealing lip 7 against the surface to be sealed of the second machine element 23.

The higher the rotational speed, the more effective is the surface structure 10, which encloses the second axial sealing lip 8 on the outer circumference.

The first axial sealing lip 7 and the second axial sealing lip 8 cooperate to achieve a good sealing effect during a long service life by minimum friction at high energy efficiency.

The sealing effect of the seal ring is essentially constant from the standstill of the first machine element 22 to be sealed up to its maximum rotational speed. When standing still, and at low rotational speed, the first axial sealing lip 7 contacts the second machine element in a sealing, adjoining manner with a relatively high axial pretension. The surface structure 10 of the second axial sealing lip 8 has practically no influence on the sealing effect.

When the rotational speed is increased, the pressing of the first axial sealing lip 7 against the second machine element 23 to be sealed decreases, wherein at the same time the effectiveness of the surface structure 10 for repelling contaminants 12 from the surroundings 13 increases.

In the exemplary embodiment shown, the seal seat 2 and the axial sealing lips 7, 8 are formed such as to merge into one another in one piece and composed of a single material and consist of a rubber-elastic sealing material. The seal ring has an L-shaped supporting body 14, which consists, for example, of a metallic material. The supporting body ensures good dimensional stability of the seal ring.

The axial leg 15 of the supporting body 14 brings about a good sealing effect of the static seal seat 2 on the surface of the first machine element 22. In contrast, the axial sealing lips 7, 8 are hinged to the radial leg 16.

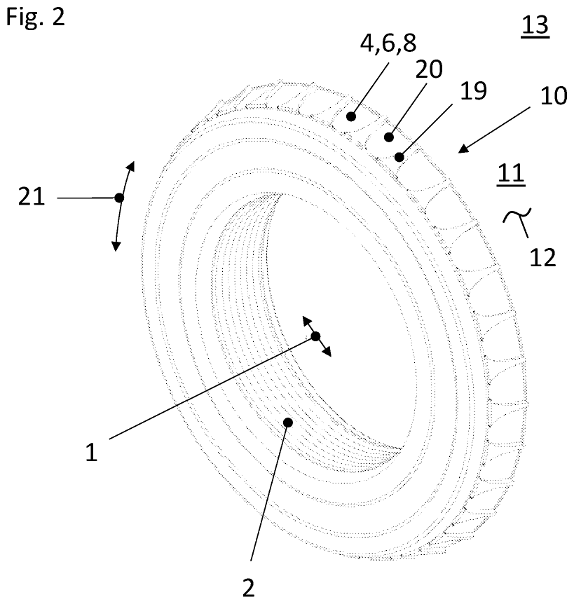

FIG. 2 shows a perspective view of the seal ring of FIG. 1.

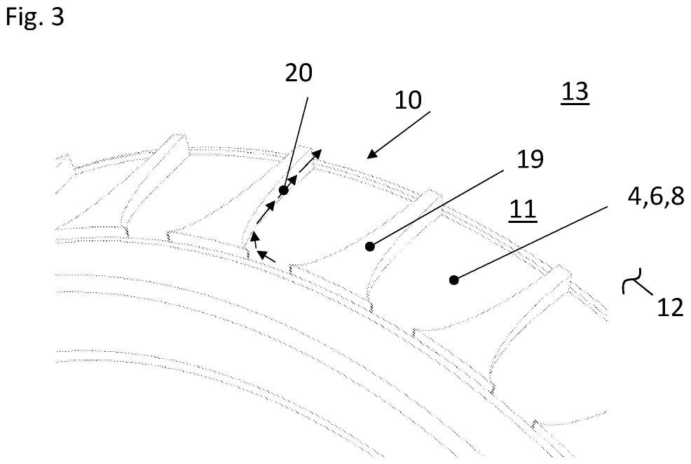

FIG. 3 shows the outer circumference of the seal ring of FIG. 2 in an enlarged view. The surface structure 10 is formed by elevations 19 and depressions 20, wherein the elevations 19 and the depressions 20 extends alternately along the circumference in the circumferential direction 21.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A seal ring, comprising:
a static seal seat arranged inside the seal ring in a radial direction; and
two sealing lips arranged outside the seal seat in the radial direction, the two sealing lips comprising axial sealing lips, one sealing lip of the axial sealing lips comprises a radially inner first and an other sealing lip of the axial sealing lips comprising a radially outer second axial sealing lip, the second axial sealing lip enclosing the first axial sealing lip at a radial distance on an outer circumference,
wherein the first axial sealing lip has greater flexibility in the radial direction than the second axial sealing lip, and
wherein the second axial sealing lip has a surface structure radially externally on a side facing radially away from the first axial sealing lip, which surface structure is aerodynamically active during an intended use of the seal ring, so as to swirl an air layer adjoining the surface structure and an to repel contaminants from surroundings of the seal ring.

2. The seal ring of claim 1, wherein the static seal seat and the axial sealing lips each comprise of a rubber-elastic sealing material.

3. The seal ring of claim 1, wherein the static seal and the axial sealing lips are formed so as to merge into one another in one piece and comprise a single material.

4. The seal ring of claim 1, wherein the seal ring comprises an essentially L-shaped supporting body comprising a tough material, and wherein the supporting body is at least essentially enclosed by the rubber-elastic sealing material.

5. The seal ring of claim 4, wherein the supporting body comprises an axial leg, which radially encloses the static seal seat on the outer circumference.

6. The seal ring of claim 4, wherein the supporting body comprises a radial leg to which the axial sealing lips are hinged.

7. The seal ring of claim 1, wherein the first axial sealing lip has, on a side facing away from a free end, an articulated root region that is tapered when viewed in cross-section.

8. The seal ring of claim 1, wherein the surface structure has elevations and depressions, which are formed in an alternating manner when viewed in a circumferential direction.
